(19) United States
(12) Patent Application Publication
(10) Pub. No.: US 2006/0289603 A1
(43) Pub. Date: Dec. 28, 2006

(54) APPARATUS AND PROCESS FOR FRICTION STIR WELDING

(75) Inventors: Rudolph Zettler, Geesthacht (DE); Shahram Sheikhi, Escheburg (DE); Mathias Beyer, Reppenstedt (DE); Jorge F. dos Santos, Avendorf (DE); Arne Roos, Juliusburg (DE); Henry Loitz, Hamburg (DE)

Correspondence Address: HOVEY WILLIAMS LLP, 2405 GRAND BLVD., SUITE 400, KANSAS CITY, MO, 64108, US

(73) Assignee: GKSS-FORSCHUNGSZENTRUM GEESTHACHT GMBH, Geesthacht (DE)

(21) Appl. No.: 11/426,854

(22) Filed: Jun. 27, 2006

(30) Foreign Application Priority Data
Jun. 27, 2005 (DE) 102005029881.8

(51) Int. Cl. B23K 20/12; B23K 37/00

(52) U.S. Cl. 228/2.1; 228/112.1

(57) ABSTRACT

The invention illustrates and describes an apparatus for friction stir welding having a pin (3) and a first friction surface segment (4), the pin (3) and the first friction surface segment (4) being driven in rotation about an axis of rotation (6), and the first friction surface segment (4) having a first friction surface (5) for resting on a workpiece (2), as well as a friction stir welding process. The object of providing an apparatus and a process for friction stir welding which allow better setting of the properties of the weld seam is achieved byvirtue of the fact that there is a feed device for introducing a filler material into the weld seam.

### RELATED APPLICATION

This Application claims priority of German Application Serial No. DE 10 2005 029 881.8, filed Jun. 27, 2005, which is hereby incorporated by reference herein.

### BACKGROUND OF THE INVENTION

1. Field of the Invention

The present invention relates to an apparatus for friction stir welding having a pin and a first friction surface segment, the pin and the first friction surface segment being rotationally driven about an axis of rotation, and the first friction surface segment having a first friction surface for resting on a workpiece, and to a friction stir welding process.

2. Discussion of Prior Art

The principle of friction welding has been known from the prior art for many years and involves a relative movement between two workpieces while these workpieces are being pressed against one another along a contact line. The friction generates a plasticized zone along the contact line, so that when the relative movement comes to a stop the plasticized zone can solidify and the workpieces are joined to one another. This technique is advantageous in particular for welding aluminium and its alloys. With conventional welding techniques, these materials can combine with the atmospheric oxygen to form oxides preventing the formation of a weld seam of sufficient strength. By contrast, this disruptive effect of oxide formation does not occur during friction welding.

However, one drawback of friction welding is that a relative movement is required between the workpieces that are to be joined. This constitutes a problem in particular if large workpieces are to be joined to one another, since this requires apparatuses and fixtures which have to hold the entire workpieces and move them with respect to one another. To avoid this problem, there has been a move towards friction stir welding (FSW). It is known from WO 93/10935 to introduce a pin into the joint between workpieces which adjoin one another and are to be joined to one another and to then set this pin in rotation, the pin having a higher hardness and a higher melting point than the material of the workpieces. While the pin is rotating, the workpieces are pressed onto one another, so that the friction between the pin and the workpieces plasticizes the edge region of both workpieces. If the pin is moved onwards along the joint, the plasticized material solidifies again and it is in this way possible to produce a weld seam.

To achieve sufficient friction even in the region close to the surface of the joint, it has proven advantageous to provide shoulders above and/or below the pin, resting on a surface of the workpieces that are to be joined and, together with the pin, also rubbing against the material. To this end, it is known from U.S. Pat. No. 6,199,745 to control the force with which the shoulders are pressed onto the top side and the underside of the workpieces separately in order to achieve an optimum distribution of heat over the cross-sectional area of the joint.

U.S. Pat. No. 6,758,382 likewise discloses controlling the pressures with which the upper and lower shoulders are pressed onto the surfaces of the workpiece and the position of the shoulders relative to the workpieces. Furthermore, the lower shoulder is releasably connected to the pin, so that it can easily be removed and therefore the apparatus can be used even in situations in which the workpieces are resting on a base.

A further problem is that the properties of the weld seam are determined by the temperature distribution and the mass transfer caused by the friction between pin and shoulder(s) and the workpieces. Therefore, the properties of the weld seam can only be influenced by changing the rotational speed of the pin and shoulder(s) and the speed at which the pin is moved linearly along the joint, and consequently targeted influencing of the properties is only possible to a limited extent.

In certain situations, however, it is necessary not only to modify the parameter of the energy introduced by friction, but rather it may also be necessary to influence the stoichiometry in the region of the weld seam in order to improve the properties of the weld seam.

### SUMMARY OF THE INVENTION

Therefore, the present invention is based on the object of providing an apparatus and a process for friction stir welding which can be used to better set the properties of the weld seam.

With regard to an apparatus, this object is achieved by virtue of the fact that there is a feed device for introducing a filler material into the weld seam.

The feed device allows targeted introduction of filler materials which influence the properties of the weld seam, with the result that the mechanical properties of the temporarily plasticized zone can be improved. In particular, the tensile strength, the subsequent weldability in the temporarily plasticized zone, the corrosion resistance and the breaking strength can be locally altered. It is in this context particularly advantageous that this influencing remains locally limited. Therefore, the apparatus according to the invention can be used not only to join two workpieces, but rather it is also possible for it to be used for the defined modification of limited portions.

In the case of the friction stir welding of workpieces made from aluminium or alloys thereof, the filler materials may in particular be copper, manganese, silicon, magnesium, zinc or aluminium oxide. In this context, copper has the advantage of increasing the tensile strength in the region of the weld seam. Manganese increases the strength without causing a loss of ductility. If silicon is introduced into the region of the weld seam, this reduces the melting temperature of the material which forms the weld seam. Magnesium as filler material is associated with the advantage of increasing the strength and corrosion resistance of the material of the weld seam compared to the aluminium of the workpieces that are to be joined. Zinc and magnesium also improve the tensile strengths. Aluminium oxide as filler material, finally, leads to an improvement in the surface hardness and wear resistance and to an increase in the strength.

In a preferred embodiment, the feed device is designed as an outer passage which has an outlet opening that is arranged adjacent to the outer surface, running parallel to the pin, of the first friction surface segment. This allows the filler material to be fed to the plasticized zone in a simple way without major structural outlay.

In another preferred embodiment, the filler material is introduced into the interior of the plasticized zone by virtue of the feed device being formed as a central passage in the pin, the central passage having an outlet opening and the outlet opening being arranged in that part of the pin which projects beyond the first friction surface. It is in this way possible to deliberately influence the bulk properties of the weld seam. In this case, the filler material which is introduced can diffuse from the pin further into the plasticized zone.

It is in this case particularly preferable if the central passage has a first portion, which runs parallel to the axis of rotation in the direction in which the pin extends, and an end portion, which extends from the end of the first portion to the peripheral surface of the pin. The central passage, which coincides with the axis of rotation of the pin, means that there is no need to provide technically complex lead-throughs.

As an alternative or in addition, the filler material can also be applied to the surface of the plasticized zone, so that in particular the composition of that part of the weld seam which is close to the surface can be modified. For this purpose, in a preferred embodiment the feed device is designed as a friction surface passage which has an outlet opening that is provided in the first friction surface segment and is arranged in the first friction surface. This has the associated advantage that the filler material, after it has been applied to the surface, is distributed by the first friction surface segment moving over the plasticized zone.

Furthermore, it is preferable if the feed device is formed by an inner gap which adjoins the first friction surface segment towards the axis of rotation. In this case, there is no need for lead-throughs for the filler material. The same advantage is achieved if the feed device is formed by an outer gap which is formed between the first friction surface segment and a first outer segment.

Moreover, the above object is achieved by a process for friction stir welding, in which a first workpiece is provided and in which a zone of the first workpiece is plasticized by a pin rotating about an axis of rotation, wherein a filler material is introduced into the plasticized zone.

The advantages which have already been referred to in the context of the abovementioned apparatus equally apply to the process. Therefore, the process according to the invention can be used to locally influence materials properties of a workpiece in a targeted way, and the process is not restricted to the joining of two workpieces.

In a preferred embodiment of the process according to the invention, a second workpiece is provided, the second workpiece is placed against the first workpiece along a joining surface, and a zone of the first workpiece and/or the second workpiece, which extends along the joining surface, is plasticized. In this way, the process according to the invention can be used to weld together two workpieces, and the materials properties of the weld seam can be influenced in a targeted way by the addition of filler materials.

Other aspects and advantages of the present invention will be apparent from the following detailed description of the preferred embodiments and the accompanying drawing figures.

### BRIEF DESCRIPTION OF THE DRAWING FIGURES

Preferred embodiments of the invention are described in detail below with reference to the attached schematic figures, wherein:

FIG. 1 shows a first embodiment of a friction stir welding apparatus according to the present invention, and

FIG. 2 shows a second embodiment of a friction stir welding apparatus according to the invention.

The drawing figures do not limit the present invention to the specific embodiments disclosed and described herein. The drawings are not necessarily to scale, emphasis instead being placed upon clearly illustrating the principles of the preferred embodiment.

### DETAILED DESCRIPTION OF THE PREFERRED EMBODIMENTS

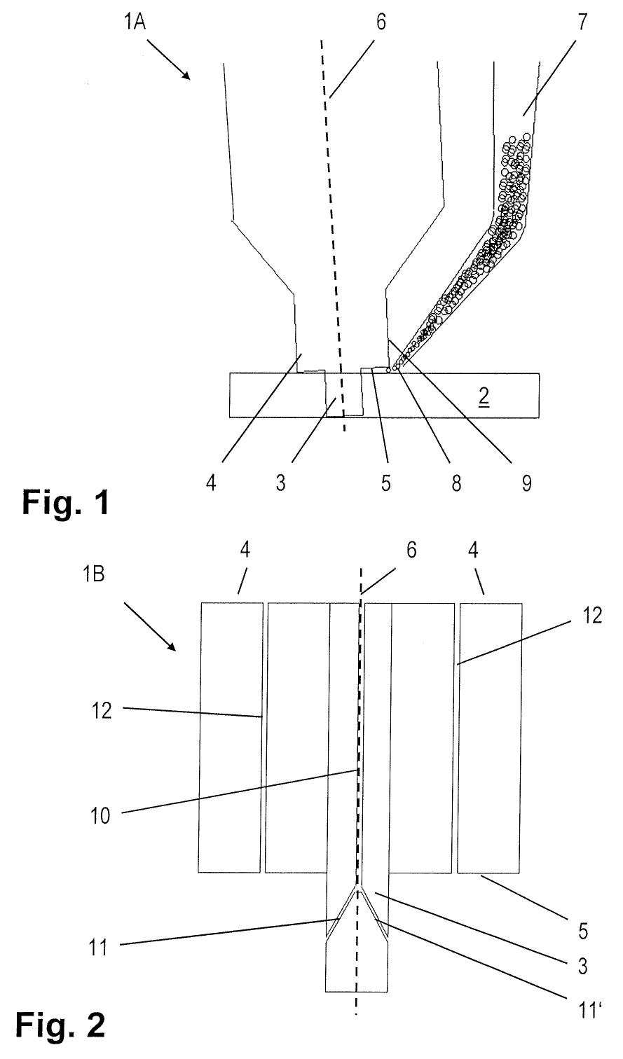

FIG. 1 shows a first exemplary embodiment of a friction stir welding apparatus 1A according to the invention, which can be guided along the joint along which two workpieces 2 bear against one another. However, the apparatus 1A is not restricted to being used to join two workpieces, but rather can also be employed to modify the materials properties of a limited zone of a workpiece 2.

The apparatus 1A comprises a pin 3 and a first friction surface segment 4, the first friction surface segment 4 having a first friction surface 5, which rests on the surface of the workpiece 2. Both the first friction surface segment 4 and the pin 3 are rotationally driven about a common axis of rotation 6. The apparatus 1A also comprises a feed device for a filler material, which in the present exemplary embodiment is formed as an outer passage 7, the outer passage 7 having an outlet opening 8 which is arranged adjacent to the outer surface 9, running parallel to the pin 3, of the friction surface element 4.

The outer passage 7 can be used to introduce a filler material between the surface of the workpiece 2 and the first friction surface 5, so that the filler material is introduced into the weld seam formed as a result of the pin 3 and the first friction surface 5, as they rotate about the axis of rotation 6, first of all plasticizing a zone of the workpiece 2 through friction, and this zone of the workpiece 2 then solidifying again. In the case of the friction stir welding of workpieces 2 made from aluminium or alloys thereof, the filler materials may in particular be copper, manganese, silicon, magnesium, zinc or aluminium oxide.

The apparatus 1A can also be used in such a manner that a second workpiece (not shown) is provided, that the second workpiece is placed against the first workpiece 2 along a joining surface, and that a zone of the first workpiece 2 and/or of the second workpiece, which extends along this joining surface, is plasticized by the rotating pin 3 moving along the joining surface. During this process, the workpieces are pressed against one another, so that a weld seam, the materials properties of which can be influenced in a targeted way by the addition of a filler material, is formed by the solidification of the temporarily plasticized zone.

FIG. 2 shows a second exemplary embodiment of an apparatus according to the invention. The apparatus 1B once again comprises a pin 3 and a first friction surface segment 4, which has a first friction surface 5 for resting on a workpiece 2. In this case, the first friction surface segment 4 is designed in the form of a circular ring and surrounds the pin 3. The pin 3 and the first friction surface segment 4 are rotationally driven about a common axis of rotation 6. In this exemplary embodiment, which is preferred in this respect, the feed device is on the one hand formed as a central passage running within the pin 3, which includes a first portion 10 running parallel to the axis of rotation 6 in the direction in which the pin 3 extends, and end portions 11, 11′, which extend from the end of the first portion 10 to the peripheral surface of the pin 3. Therefore, the outlet opening is arranged in that part of the pin 3 which projects beyond the first friction surface 5.

Furthermore, the feed device comprises friction surface passages 12, which are provided in the friction surface segment 4 and the outlet opening of which is arranged in the first friction surface 5. A filler material can be introduced into the interior of the zone of the workpiece 2 which has been plasticized by the pin 3 via the central passage having the end portions 11, 11′ which end in the peripheral surface of the pin 3, while filler materials can be introduced into the zone of the weld seam which is close to the surface through the friction surface passages 12. In the latter case, the distribution of the filler material over the surface is assisted by the rotating movement of the first friction surface 5.

In addition to the possibility of providing either an outer passage 7 or a central passage or friction surface passages 12, according to the present invention the filler material can also be supplied through a gap which adjoins the first friction surface segment 4 towards the axis of rotation 6. This relates in particular to a gap between the first friction surface segment 4 and the pin 3. Alternatively, it is also possible to provide a first outer segment (not shown), which surrounds the first friction surface segment 4, and for the filler material to be introduced through an outer gap which is formed between the first friction surface segment 4 and a first outer segment.

Two workpieces 2 can be joined to one another along a joining surface in such a manner that a zone of the first workpiece 2 and/or the second workpiece which is arranged adjacent to the joining surface is plasticized by the pin rotating about the axis of rotation 6. It is in this case on the one hand conceivable for the joining surface to run along the joint at which the two workpieces bear against one another. In this case, the apparatus 1A or 1B, having the pin 3 and the friction surface segment 4, which are rotating about the axis of rotation 6, are moved along the joining surface, so as to plasticize those zones in the two workpieces 2 which adjoin the joining surface. As the apparatus 1A or 1B moves along the joining surface, a filler material is introduced into the plasticized zone, this taking place through the outer passage 7 in accordance with the first exemplary embodiment, which is illustrated in FIG. 1, and the filler material being applied to the surface of the plasticized zone through the outlet opening 8 arranged at the outer periphery of the first friction surface segment 4.

As shown in FIG. 1, the pin 3 is preferably guided in such a manner with respect to the first and second workpieces 2 that the axis of rotation 6 runs at an angle to the normal to the surface of the workpieces 2. Therefore, the pin 3 is guided at an angle, so that the first friction surface 5 does not rest completely on both workpieces 2. In this way, the filler material can be introduced beneath the first friction surface 5, so that it can be successfully distributed over the surface of the plasticized zone.

If an apparatus 1B in accordance with the second exemplary embodiment, as shown in FIG. 2, is used, the filler material can on the one hand be introduced into the interior of the plasticized zone by being fed through the central passage having the first portion 10 and the end portions 11, 11′. On the other hand, the filler material can also be applied to the surface of the plasticized zone by being passed through the friction surface passages 12. It is in this context conceivable for a different filler material to be introduced into the interior of the weld seam from the filler material applied to the surface.

The apparatuses 1A, 1B according to the invention therefore allow the materials properties of limited zones of a workpiece 2 or those of a weld seam to be modified or influenced in a targeted way.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and assess the reasonably fair scope of the present invention as pertains to any apparatus not materially departing from but outside the literal scope of the invention as set forth in the following claims.

What is claimed is:

1. An apparatus for friction stir welding of a workpiece, wherein the apparatus forms a plasticized zone of the workpiece, said apparatus comprising:
a pin operable to form the plasticized zone when rotated;
a first friction surface segment,
said pin and said first friction surface segment being rotationally driven about an axis of rotation,
said first friction surface segment having a first friction surface for resting on the workpiece; and
a feed device for introducing filler material into the plasticized zone.

2. The apparatus according to claim 1,
wherein the feed device is designed as an outer passage which has an outlet opening that is arranged adjacent to an outer surface of the first friction surface segment, which surface runs parallel to the pin.

3. The apparatus according to claim 1,
wherein the feed device is formed as a central passage in the pin, the central passage has an outlet opening, and the outlet opening is arranged in that part of the pin which projects beyond the first friction surface.

4. The apparatus according to claim 3,
wherein the central passage has a first portion, which runs parallel to the axis of rotation in the direction in which the pin extends, and the central passage has an end portion, which extends from the end of the first portion to the peripheral surface of the pin.

5. The apparatus according to claim 1,
wherein the feed device is designed as a friction surface passage which has an outlet opening that is provided in the first friction surface segment, and the outlet opening is arranged in the first friction surface.

6. The apparatus according to claim 1,
wherein the feed device is formed by an inner gap which adjoins the first friction surface segment in the direction of the axis of rotation.

7. The apparatus according to claim 1; and
a first outer segment surrounding the first friction surface segment, wherein the feed device is formed by an outer gap which is formed between the first friction surface segment and the first outer segment.

8. A process for friction stir welding, comprising the steps of:
(a) providing a first workpiece,
(b) plasticizing a zone of the first workpiece by rotating a pin about an axis of rotation, and
(c) introducing a filler material into the plasticized zone.

9. The process according to claim 8,
(d) providing a second workpiece,
(e) placing the second workpiece against the first workpiece along a joining surface, wherein a zone of the first workpiece or the second workpiece, which extends along the joining surface, is plasticized.

10. The process according to claim 9,
step (c) including the step of introducing the filler material into the interior of the plasticized zone.

11. The process according to claim 10,
(f) passing the filler material through a central passage in the pin.

12. The process according to claim 9,
step (e) including the step of applying the filler material to the surface of the plasticized zone.

13. The process according to claim 12,
step (b) including the step of rotating a friction surface segment having a friction surface about the axis of rotation, the friction surface at least partially resting on the workpieces, and
step (c) including the step of applying the filler material to that surface of the workpieces which faces towards the friction surface.

14. The process according to claim 13,
step (b) including the step of guiding the pin in such a manner with respect to the first and second workpieces that the axis of rotation runs at an angle to the normal to the surface of the workpieces.

15. The process according to claim 13,
(f) passing the filler material through a friction surface passage running through the friction surface segment.

16. The process according to claim 13,
(f) passing the filler material through a gap which adjoins the friction surface segment.

17. The process according to claim 16,
(f) passing the filler material through a gap between the friction surface segment and an outer segment which surrounds the friction surface segment.

18. The process according to claim 9,
wherein the filler material is a material selected from the list consisting of copper, manganese, silicon, magnesium, zinc and aluminium oxide.
